(19) United States
(12) Patent Application Publication
(10) Pub. No.: US 2010/0203272 A1
(43) Pub. Date: Aug. 12, 2010

(54) METHOD FOR PRODUCING A MOTOR VEHICLE COMPONENT, AND A MOTOR VEHICLE COMPONENT

(75) Inventors: JOHANNES SCHÄFERS, Borchen (DE); ULRICH LÜTKE-BEXTEN, Paderborn (DE); MARKUS KETTLER, Paderborn (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Automobiltechnik GmbH, Paderborn (DE)

(21) Appl. No.: 12/699,323

(22) Filed: Feb. 3, 2010

(30) Foreign Application Priority Data
Feb. 6, 2009 (DE) 10 2009 007 901.7

(51) Int. Cl. B32B 1/06; B28B 1/14

(52) U.S. Cl. 428/35.7; 264/319

(57) ABSTRACT

A method for producing a motor vehicle component and a motor vehicle component produced by this method are disclosed. A tubular body made of metal, in particular high-strength steel, is filled with a granular material and subsequently heated. During the heat treatment, the granular material melts and then hardens during cool-down to form an interior reinforcement.

### CROSS-REFERENCES TO RELATED APPLICATIONS

This application claims the priority of German Patent Application, Serial No. 10 2009 007 901.7, filed Feb. 6, 2009, pursuant to 35 U.S.C. 119(a)-(d), the contents of which are incorporated herein by reference in its entirety as if fully set forth herein.

### BACKGROUND OF THE INVENTION

The present invention relates to a method for producing a motor vehicle component, which has a tubular body made of metal with an interior reinforcement, and a motor vehicle component of this type.

The following discussion of related art is provided to assist the reader in understanding the advantages of the invention, and is not to be construed as an admission that this related art is prior art to this invention.

Lightweight components intended reduce the weight of a motor vehicle by as much as possible have become increasingly important in the construction of motor vehicles. Such lightweight components must be amenable to a continuous, dimensionally-stable series production and must have high stiffness and structural stability in order to withstand the high static and, in particular, dynamic loading which motor vehicle components are subjected during operation. Motor vehicle components are predominantly manufactured from sheet steel or structural sheet steel or steel tubes. Weight can be reduced by employing structural components that have thinner walls compared to conventional motor vehicle components. Components with thinner walls, however, may not be able to attain the desired stiffness and stability values. It has therefore been proposed, for example in DE 199 59 814 B4 or U.S. Pat. No. 4,978,562, to fill vehicle components with foam and to thereby provide these components with an interior coating.

U.S. Pat. No. 7,083,751 B2 discloses a method for producing a motor vehicle component having a tubular body made of metal with an interior reinforcement. The tubular body is filled with two granular components and subsequently heated, whereby the granular material subsequently hardens due to the melting and expansion of the granular components, thereby forming the interior reinforcement.

DE 196 35 734 A1 discloses a reinforced formed part and a method for producing a formed part, wherein the formed part includes an outer hollow formed part in which a foam filling is introduced. The foam filling hereby at least partially contacts and at least partially fills the outer formed part.

DE 600 18 612 T2 discloses a method for forming a reinforced structural component. An outer structural component is here paired with an inner structural component by insertion into an opening. The periphery of the inner structural component is already coated with structural foam. The produced assembly is reformed by hydroforming and subsequently heated to cause expansion of the structural foam between the outer and the inner structural components.

The aforedescribed solutions are quite acceptable. All the aforedescribed methods are intended to increase the stiffness and stability of the components by way of interior reinforcement. In addition to cold-foaming, possibilities are discussed for subsequently activating the form by applying heat after the component is formed and structured.

However, it would still be desirable and advantageous to obviate prior art shortcomings by providing a method by which a motor vehicle component with a tubular body having an interior reinforcement can be produced more economically and cost-effectively.

### SUMMARY OF THE INVENTION

According to one aspect of the present invention, a method for producing a motor vehicle component having a thin-walled tubular body made of metal, includes the steps of filling the tubular body with a granular material, heating the filled tubular body concurrent with a tempering process of the tubular body to cause the granular material to melt, and cooling the filled tubular body to cause the granular material in the filled tubular body to solidify and harden, and form an interior reinforcement of the tubular body.

This approach is cost effective and economical. The method allows the manufacture of lightweight motor vehicle components with a thin wall outer skin made of steel and an interior reinforcement which is also lightweight. Overall, the invention provides potentially large weight reductions. The produced motor vehicle components additionally have high fatigue strength and buckling resistance with a component-specific deformation characteristic and small risk of fracture.

Embodiments of the invention may include one or more of the following features.

The granular material may be melted in the tubular body by applying heat to the filled tubular body in the course of a tempering process, where the tubular body is heated to a temperature above 900° C. and subsequently cooled down.

The granular material may be introduced into a tubular body made of metal as a loose bulk material. The pourable granular material is easily distributed in the tubular body. The ends of the tubular body may be closed off during the filling operation or after the tubular body has been filled with granular material. The tube ends can be flattened. Alternatively, the tube ends can be closed off with plugs. Bores can be introduced in the flattened tube ends, which can later be used to attach the motor vehicle component to the structure of a vehicle with screw. When plugs are used to close the tube ends, the plugs can already have threaded bores, for example formed in blind holes, by which the motor vehicle components can be screwed together.

The tubular bodies as well as the flattened tube ends and/or the plugs can also be provided with additional support elements or attachment parts.

The interior reinforcement formed by the hardened melt can completely fill the tubular body. However, the interior reinforcement may fill the tubular body only partially, in particular by forming an interior layer contacting the inner wall of the tube body which can optionally be attached to the inner wall by an adhesive. Advantageously, the tubular body may be moved, in particular rotated about its longitudinal axis, while the granular material hardens, to produce a uniform distribution of the melt on the inner wall of the tubular body.

Advantageously, a thin-walled tubular body made of steel, in particular made of high-strength steel, may be used.

The granular material may be composed of plastic, lightweight metal, in particular aluminum, or cellulose. Other granular materials which can form a melt and have sufficiently high rigidity after solidification or hardening can also be employed.

According to another aspect of the present invention, a motor vehicle component includes a tubular body made of metal and having flattened sections, and an interior reinforcement made of a granular material. The interior reinforcement is produced by filling the tubular body with a granular material, heating the filled tubular body concurrent with a tempering process of the tubular body to cause the granular material to melt, and solidifying and hardening the granular material in the filled tubular body.

According to yet another aspect of the present invention, a motor vehicle component includes a tubular body made of metal and having tube ends, a plug inserted in each of the tube ends, wherein each plug has a blind hole with an internal thread and closes off a respective tube end, and an interior reinforcement made of a granular material. The interior reinforcement is produced by filling the tubular body with a granular material, heating the filled tubular body concurrent with a tempering process of the tubular body to cause the granular material to melt, and solidifying and hardening the granular material in the filled tubular body.

Examples of such motor vehicle components are door reinforcements, side impact supports, bumper cross beams, and bumper-, A-, B- or C-column reinforcements as well as rocker panel reinforcements.

According to the invention, the tubular body has flattened end sections, in which bores may be inserted to provide a screw connection. The end sections may also be provided with supports or attachment parts. The interior reinforcement provides the thin wall tubular component, which is preferably made of high-strength steel, with increased rigidity and dimensional stability. A further weight reduction can thus be attained. The motor vehicle component has nevertheless excellent deformation characteristics and is flexible in the event of a crash and has a small risk of fracture, in particular of the reinforcement.

According to another embodiment of the motor vehicle component, the tube ends of the tubular body may be closed off by blind holes having an internal thread. The motor vehicle component can be attached with screws engaging in the threaded bores.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows in a side view a tubular body as a starting product for the production of a motor vehicle component according to the invention;

FIG. 2 shows the tubular body according to FIG. 1 with flattened tube ends and filled with granular material;

FIG. 3 shows a detail of a tube end of a tubular body with the end closed off with a plug;

FIG. 4 shows a first embodiment of a motor vehicle component according to the invention in cross-section; and

FIG. 5 shows a second embodiment of a motor vehicle component according to the invention in cross-section.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

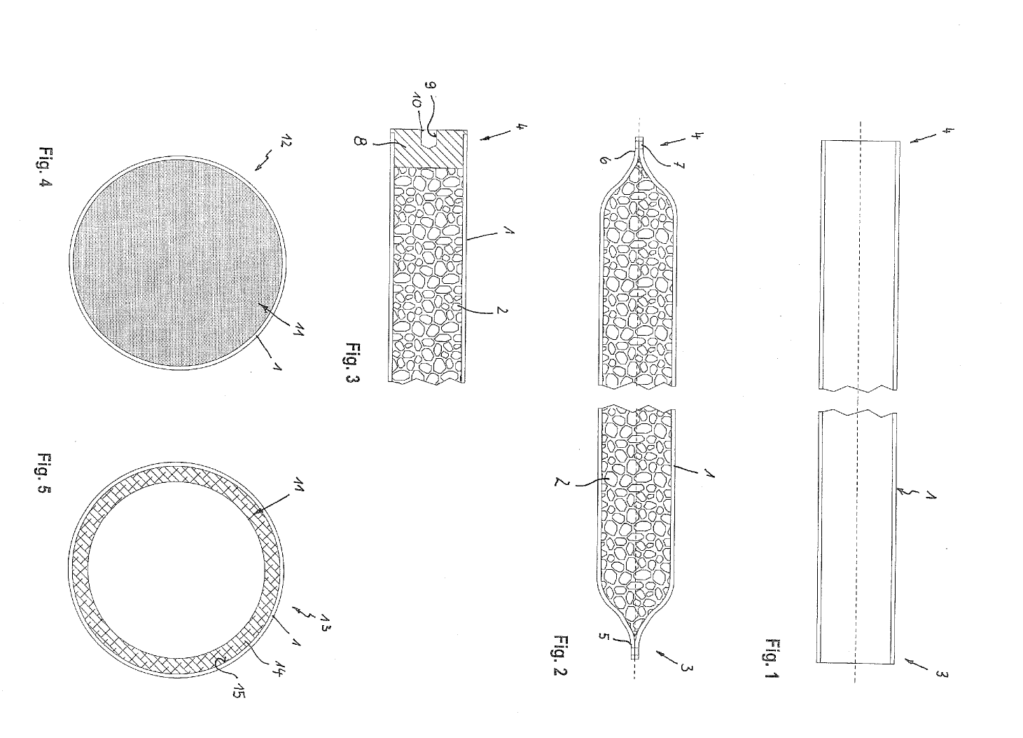

Turning now to the drawing, and in particular to FIG. 1, there is shown a tubular body 1 made of high-strength steel. A motor vehicle component is produced by filling the tubular body 1 with a granular material 2 (see FIGS. 2 and 3). The granular material 2 can be composed of plastic, lightweight metal, in particular aluminum or an aluminum alloy, or cellulose.

In the embodiment depicted in FIG. 2, the tubular body 1 is first flattened on one end 3 and subsequently filled with a granular material 2. After the tubular body 1 is filled with the granular material 2, the other end 4 is also flattened, so that both ends of the tubular body 1 are closed off after the tubular body 1 is filled. Bores 7 can be inserted in the flattened end sections 5, 6 which serve as attachment points for screws.

FIG. 3 shows an alternative embodiment where the tubular body 1 is closed off with plugs 8 at both ends. In the illustrated exemplary embodiment, the plugs 8 have blind holes 10 with an internal thread 9, which can be used for subsequent screw assembly.

The tubular body 1 filled with granular material 2 is subjected to heat treatment in the course of a tempering process, whereby the granular material 2 melts and subsequently hardens during cool-down to form an interior reinforcement 11.

In the exemplary embodiment of a motor vehicle component 12 illustrated in FIG. 4, the tubular body 1 made of steel is completely filled by the interior reinforcement 11.

In the motor vehicle component 13 according to FIG. 5, the tubular body 1 made of high-strength steel is partially filled by the interior reinforcement 11 which forms an inner tube 14 contacting the inside wall 15 of the tubular body 1. Motor vehicle component 13 of this type can be produced by rotating the tubular body about its longitudinal axis while the granular material 2 is in a molten state, until the granular material 2 solidifies, which uniformly distributes the molten granular material 2 on the inside wall 15.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for producing a motor vehicle component having a tubular body made of metal, comprising the steps of:
filling the tubular body with a granular material,
heating the filled tubular body concurrent with a tempering process of the tubular body to cause the granular material to melt, and
solidifying and hardening the granular material to form an interior reinforcement of the tubular body.

2. The method of claim 1, wherein the tubular body is heated to a temperature above 900° C. and subsequently cooled.

3. The method of claim 1, wherein the tubular body includes tube ends, and further comprising the step of closing off the ends after the tubular body is filled with the granular material.

4. The method of claim 3, wherein the tube ends of the tubular body are flattened to close them off.

5. The method of claim 4, wherein the flattened tube ends comprise bores.

6. The method of claim 3, and further inserting plugs into the tube ends of the tubular body.

7. The method of claim 1, wherein the interior reinforcement completely fills the tubular body.

8. The method of claim 1, wherein the interior reinforcement partially fills the tubular body.

9. The method of claim 1, wherein the tubular body is moved during hardening of the molten granular material.

10. The method of claim 1, wherein the tubular body is rotated about a longitudinal axis of the tubular body during hardening of the molten granular material.

11. The method of claim 1, wherein the tubular body is made of steel.

12. The method of claim 11, wherein the tubular body is made of high-strength steel.

13. The method of claim 1, wherein the granular material comprises a plastic material.

14. The method of claim 1, wherein the granular material comprises a lightweight metal.

15. The method of claim 14, wherein the granular material comprises aluminum.

16. The method of claim 1, wherein the granular material comprises cellulose.

17. A motor vehicle component comprising:
a tubular body made of metal and having flattened sections; and
an interior reinforcement made of a granular material, said interior reinforcement produced by
filling the tubular body with a granular material,
heating the filled tubular body concurrent with a tempering process of the tubular body to cause the granular material to melt, and
solidifying and hardening the granular material in the filled tubular body.

18. A motor vehicle component comprising:
a tubular body made of metal and having tube ends;
a plug inserted in each of the tube ends, each plug having a blind hole with an internal thread and closing off a respective tube end; and
an interior reinforcement made of a granular material, said interior reinforcement produced by
filling the tubular body with a granular material,
heating the filled tubular body concurrent with a tempering process of the tubular body to cause the granular material to melt, and
solidifying and hardening the granular material in the filled tubular body.
